(19) United States
(12) Patent Application Publication
(10) Pub. No.: US 2013/0130712 A1
(43) Pub. Date: May 23, 2013

(54) TERMINAL APPARATUS AND METHOD FOR IDENTIFYING POSITION

(71) Applicant: Akira KARASUDANI, Yamato (JP)

(72) Inventor: Akira KARASUDANI, Yamato (JP)

(73) Assignee: FUJITSU LIMITED, Kawasaki-shi (JP)

(21) Appl. No.: 13/596,168

(22) Filed: Aug. 28, 2012

(30) Foreign Application Priority Data
Nov. 21, 2011 (JP) 2011-254455

(51) Int. Cl. H04W 24/00

(52) U.S. Cl. 455/456.1

(57) ABSTRACT

A terminal apparatus includes a processor. The processor obtains first information relating to communication states between the terminal apparatus and two or more other terminal apparatuses and between the other terminal apparatuses. The processor identifies using trilateration, based on the first information, first relative positional relationships between the terminal apparatus and the other terminal apparatuses. The processor measures, based on second information detected by a sensor, a movement direction and a movement distance of the terminal apparatus when the terminal apparatus has moved. The processor identifies second relative positional relationships between the terminal apparatus and the other terminal apparatuses after the movement of the terminal apparatus. The processor calculates a relative position and a relative direction of the terminal apparatus relative to the other terminal apparatuses, based on the first relative positional relationships, the second relative positional relationships, and the movement distance and the movement direction of the terminal apparatus.

### CROSS-REFERENCE TO RELATED APPLICATION

This application is based upon and claims the benefit of priority of the prior Japanese Patent Application No. 2011-254455, filed on Nov. 21, 2011, the entire contents of which are incorporated herein by reference.

### FIELD

The embodiments discussed herein are related to a terminal apparatus and a method for identifying a position.

### BACKGROUND

In application systems in which a plurality of terminal apparatuses operate in cooperation with one another, such as a conference system, some uses are being studied in which each terminal apparatus issues an instruction or provides data to a particular terminal apparatus while utilizing positional information of other terminal apparatuses. In such uses, as a method for identifying a position of a terminal apparatus, some methods have been proposed in which each terminal apparatus utilizes radio field intensity from a wireless access point whose position is known in advance or time differences in communication between the terminal apparatuses.

For example, a technique has been proposed in which absolute positional information regarding a terminal apparatus is obtained using a global positioning system (GPS) or the like and transmitted to a server. When the terminal apparatus does not include a GPS or the like, the absolute position may be calculated on the basis of a relative position to another terminal apparatus that includes a GPS and transmitted to the server. The relative positional relationship between the terminal apparatus and another terminal apparatus may be obtained using trilateration based on communication radio field intensity. A technique is known in which the absolute position of a terminal apparatus is identified on the basis of absolute positions, which are known in advance, of base stations, communication radio field intensity from each base station, and directivity information regarding radio receiver sensitivity relative to each direction of the terminal apparatus. However, when a terminal apparatus that does not include a GPS is used, it is difficult to use the above methods for identifying a position.

Therefore, a method has been proposed in which the absolute position of a terminal apparatus is calculated on the basis of positions, which are known in advance, of fixed base stations, communication radio field intensity from each fixed base station, and calibration data regarding known signal intensity relative to each direction of the terminal apparatus. A technique for accurately calculating a position (or an absolute position) of a moving terminal apparatus has also been proposed in which the absolute position of the terminal apparatus may be accurately calculated by calculating an absolute position of the terminal apparatus on the basis of positions, which are known in advance, of fixed base stations and communication radio field intensity from each fixed base station and then by correcting the calculated absolute position using a relative movement position obtained from a gyro sensor or an acceleration sensor or the like of the terminal apparatus. However, in these methods for identifying a position, a base station whose position is known in advance and that serves as a reference, another terminal apparatus, or the like is supposed to be provided when the terminal apparatus identifies its own position.

FIG. 1 is a diagram illustrating an example of a method for identifying a position in a related art. In FIG. 1, it is assumed that the coordinates (x1, y1) of an access point AP1 and the coordinates (x2, y2) of an access point AP2 are known in advance and registered to a database or the like. A terminal apparatus T_A obtains radio field intensity states RSSI_A1 and RSSI_A2 by communicating with the access points AP1 and AP2, respectively, and calculates distances d1 and d2 to the access points AP1 and AP2 on the basis of values of the radio field intensity states RSSI_A1 and RSSI_A2, respectively. The coordinates (xa, ya) of the position of the terminal apparatus T_A may be calculated on the basis of the distances d1 and d2 and the coordinates (x1, y1) and (x2, y2) of the access points AP1 and AP2 by solving the following simultaneous equations.

d1²=(xa−x1)²+(ya−y1)²

d2²=(xa−x2)²+(ya−y2)²

Coordinates of positions of a terminal apparatus T_B and a terminal apparatus T_C may be calculated in the same manner as when the coordinates of the position of the terminal apparatus T_A are calculated. Thus, the positions of the terminal apparatuses T_A, T_B, and T_C may be calculated.

Currently, a technique has also been proposed in which an ad hoc network is constructed using the terminal apparatus itself as an access point. However, when the terminal apparatus itself serves as an access point, there is no base station or the like whose position is known in advance and that serves as a reference. Therefore, it is difficult to identify the position of the terminal apparatus.

Japanese Laid-open Patent Publication No. 2009-17217, Japanese Laid-open Patent Publication No. 2010-78528, Japanese Laid-open Patent Publication No. 2005-176386, and Japanese Laid-open Patent Publication No. 2005-274364 disclose related techniques.

According to conventional methods for identifying a position, it is difficult to identify a position of a terminal apparatus unless there is a base station or the like whose position is known in advance and that serves as a reference.

### SUMMARY

According to an aspect of the present invention, provided is a terminal apparatus including a processor. The processor obtains first information relating to communication states between the terminal apparatus and two or more other terminal apparatuses and between the two or more other terminal apparatuses. The processor identifies using trilateration, based on the first information, first relative positional relationships between the terminal apparatus and the two or more other terminal apparatuses. The processor measures, based on second information detected by a sensor, a movement direction and a movement distance of the terminal apparatus when the terminal apparatus has moved. The processor identifies second relative positional relationships between the terminal apparatus and the two or more other terminal apparatuses after the movement of the terminal apparatus. The processor calculates a relative position and a relative direction of the terminal apparatus relative to the two or more other terminal apparatuses, based on the first relative positional relationships, the second relative positional relationships, and the movement distance and the movement direction of the terminal apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a method for identifying a position in a related art;

FIG. 2 is a diagram illustrating an example of operations according to a first embodiment;

FIG. 3 is a block diagram illustrating an example of a hardware configuration of a terminal apparatus;

FIG. 4 is a block diagram illustrating an example of functional configuration of a terminal apparatus;

FIG. 5 is a diagram illustrating an example of operations according to a first embodiment;

FIGS. 6A and 6B are flowcharts illustrating an example of operations according to a first embodiment;

FIG. 7 is a diagram illustrating an example of operations according to a second embodiment;

FIGS. 8A and 8B are flowcharts illustrating an example of operations according to a second embodiment;

FIG. 9 is a diagram illustrating an example of operations according to a second embodiment; and

FIG. 10 is a diagram illustrating an example of a screen displayed on a display device of a terminal apparatus.

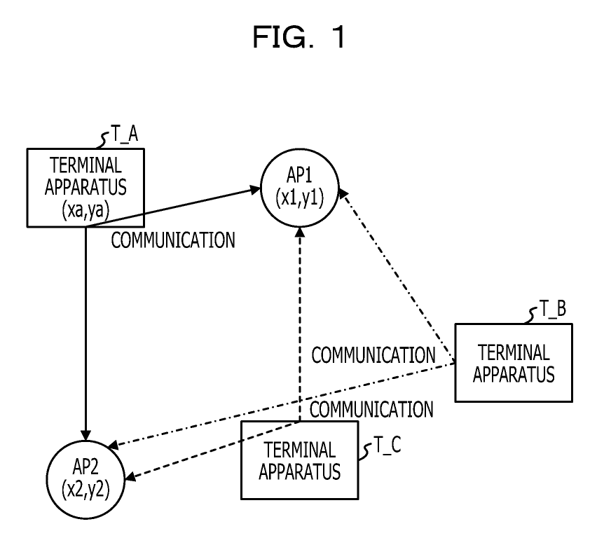

### DESCRIPTION OF EMBODIMENTS

A terminal apparatus according to an embodiment identifies relative positions of a plurality of terminal apparatuses when the plurality of terminal apparatuses perform ad hoc communication.

The terminal apparatus calculates relative positional relationships with other terminal apparatuses on the basis of communication states with the other terminal apparatuses and communication states between the other terminal apparatuses, and measures, when the terminal apparatus has moved, a movement direction and a movement distance thereof on the basis of detected information. The position and the direction of the terminal apparatus relative to the other terminal apparatuses are then calculated and identified on the basis of the relative positional relationships, the movement direction, and the movement distance.

Terminal apparatuses according to embodiments will be described hereinafter with reference to the drawings.

### First Embodiment

According to a first embodiment, the relative position and direction of each terminal apparatus is identified even when there is no base station or the like that serves as a reference for identifying the position of each terminal apparatus. More specifically, the radio field intensity states between terminal apparatuses are obtained and the relative positions of the terminal apparatuses are identified using trilateration. In addition, each terminal apparatus measures the movement direction and the movement distance thereof using a gyro sensor, a geomagnetic sensor, an acceleration sensor, or the like and combines the movement direction and the movement distance thereof with the relative positions identified in the above-described manner, in order to identify the directions of the terminal apparatuses. Thus, the relative positions, directions, and the like of the terminal apparatuses may be identified, and an application system that uses positional information may be realized in an environment in which the terminal apparatuses are collected ad hoc.

The terminal apparatus is, for example, a portable apparatus having a communication function, and may be configured by a mobile phone such as a smartphone or a computer such as a laptop or tablet personal computer (PC).

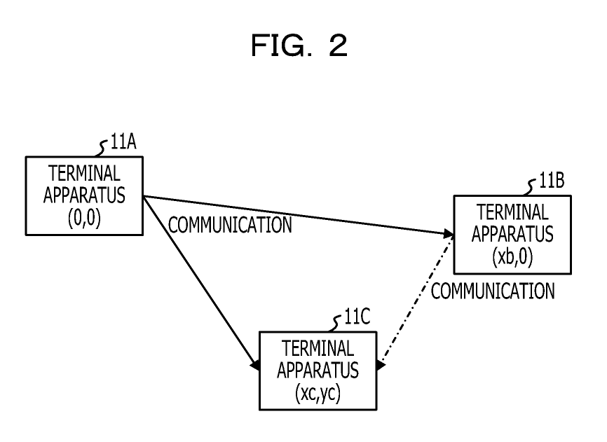

FIG. 2 is a diagram illustrating an example of operations according to the first embodiment. In this example, it is assumed that three or more terminal apparatuses perform ad hoc communication, and FIG. 2 illustrates a case in which three terminal apparatuses 11A, 11B, and 11C communicate with one another. For convenience of description, the coordinates of the position of the terminal apparatus 11A are assumed to be (0, 0), the coordinates of the position of the terminal apparatus 11B are assumed to be (xb, 0), and the coordinates of the position of the terminal apparatus 11C are assumed to be (xc, yc). The terminal apparatuses 11A, 11B, and 11C have configurations that enable wireless communication. A communication protocol to be used for the wireless communication is not particularly limited.

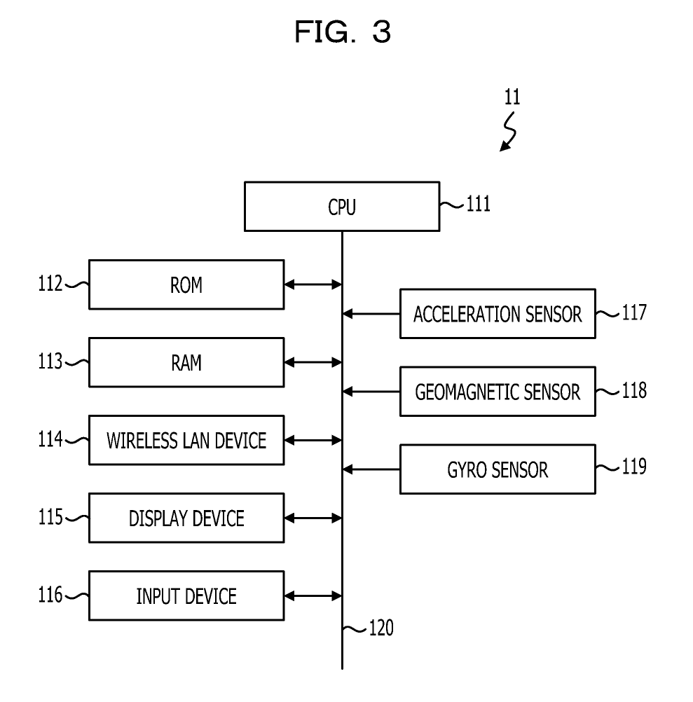

FIG. 3 is a block diagram illustrating an example of a hardware configuration of the terminal apparatus. A terminal apparatus 11 illustrated in FIG. 3 may be used as each of the terminal apparatuses 11A, 11B, and 11C illustrated in FIG. 2. The terminal apparatus 11 has a configuration in which a central processing unit (CPU) 111, which is an example of a processor, a read-only memory (ROM) 112, which is an example of a storage unit, a random-access memory (RAM) 113, which is an example of the storage unit, a wireless local area network (LAN) device 114, which is an example of a communication device (or a transmission/reception unit), a display device 115, an input device 116, an acceleration sensor 117, a geomagnetic sensor 118, and a gyro sensor 119 are connected to one another by a bus 120.

The CPU 111 realizes each function of the terminal apparatus 11 by executing a program stored in the ROM 112, for example. The RAM 113 stores various pieces of data including intermediate data regarding operations executed by the CPU 111. The wireless LAN device 114 may communicate with other terminal apparatuses 11 and the like through a wireless LAN (not illustrated) in this example. Needless to say, the transmission/reception unit may have a configuration that enables communication with other terminal apparatuses 11 through a wireless network other than the wireless LAN. The display device 115 includes, for example, a liquid crystal display (LCD), and displays various pieces of data such as a menu and a result of processing for a user. The input device 116 includes, for example, a keyboard, and is operated when the user inputs an instruction, data, or the like to the terminal apparatus 11. The acceleration sensor 117 that detects the acceleration of the terminal apparatus 11, the geomagnetic sensor 118 that detects the geomagnetism at the position of the terminal apparatus 11, and the gyro sensor 119 that detects the angular speed, the angle, and the like of the terminal apparatus 11 have respective known configurations. Alternatively, only either the acceleration sensor 117 or the gyro sensor 119 may be provided.

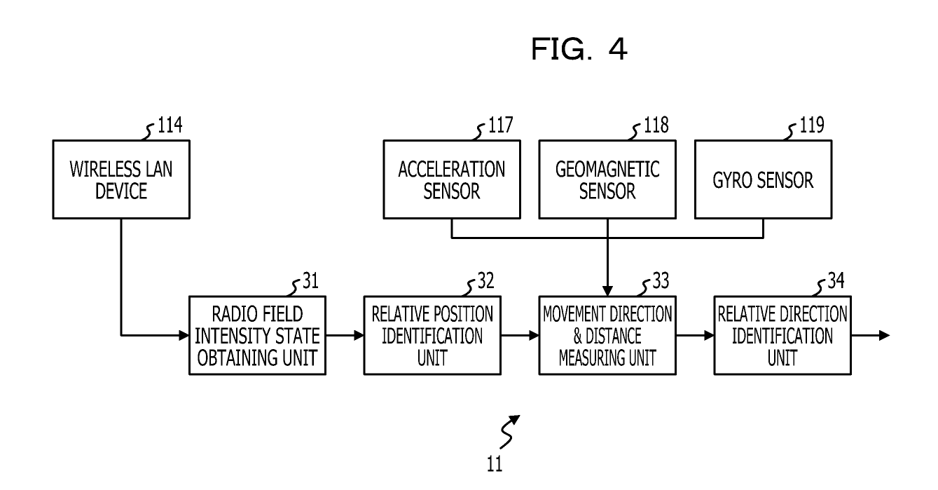

FIG. 4 is a block diagram illustrating an example of a functional configuration of the terminal apparatus. In the example illustrated in FIG. 4, the terminal apparatus 11 includes a radio field intensity state obtaining unit 31, a relative position identification unit 32, a movement direction & distance measuring unit 33, and a relative direction identification unit 34.

The radio field intensity state obtaining unit 31 monitors communication between the terminal apparatuses 11 and obtains radio field intensity states, that is, for example, received signal strength indicator (RSSI) values, between the terminal apparatuses 11. At this time, the radio field intensity states between the terminal apparatuses 11 obtained by the radio field intensity state obtaining unit 31 include not only the radio field intensity states between the terminal apparatus 11 that includes the radio field intensity state obtaining unit 31 and other terminal apparatuses 11 but also the radio field intensity states between the other terminal apparatuses 11. Therefore, in the example illustrated in FIG. 2, the terminal apparatus 11A monitors wireless communication and obtains an RSSI value (or a radio field intensity state) RSSI_AB between the terminal apparatus 11A and the terminal apparatus 11B, an RSSI value RSSI_AC between the terminal apparatus 11A and the terminal apparatus 11C, and an RSSI value RSSI_BC between the terminal apparatus 11B and the terminal apparatus 11C. As a known wireless LAN or a communication standard used to transmit the RSSI value RSSI_BC between the nearby two or more terminal apparatuses 11B and 11C to the terminal apparatus 11A, for example, IEEE 802.11a/b/g/n may be used.

The relative position identification unit 32 calculates, using the terminal apparatus 11A as an origin, a distance d_AB between the terminal apparatuses 11A and 11B, a distance d_AC between the terminal apparatuses 11A and 11C, and a distance d_BC between the terminal apparatuses 11B and 11C on the basis of the RSSI values between the terminal apparatuses 11, and identifies the coordinates of the terminal apparatus 11B and the terminal apparatus 11C through calculation using trilateration. If the Y coordinate yb of the terminal apparatus 11B is assumed to be 0 as with the terminal apparatus 11A, the following simultaneous equations may be solved.

d_{—}AB²=(xb)²+(yb=0)²

d_{—}AC²=(xc)²+(yc)²

d_{—}BC²=(xb−xc)²+(yc)²

Thus, the relative positions (0, 0), (xb, 0), and (xc, yc) of the terminal apparatus 11A, the terminal apparatus 11B, and the terminal apparatus 11C, respectively, may be calculated, and accordingly a relative position RP_{A} of the terminal apparatus 11A relative to the terminal apparatus 11B and the terminal apparatus 11C may be obtained. However, at this time, since the position RP_{A} of the terminal apparatus 11A relative to the terminal apparatus 11B and the terminal apparatus 11C is known, the positional relationships of the terminal apparatus 11A with the terminal apparatuses 11B and 11C are known, but the directions of the terminal apparatuses 11B and 11C from the terminal apparatus 11A are not clear.

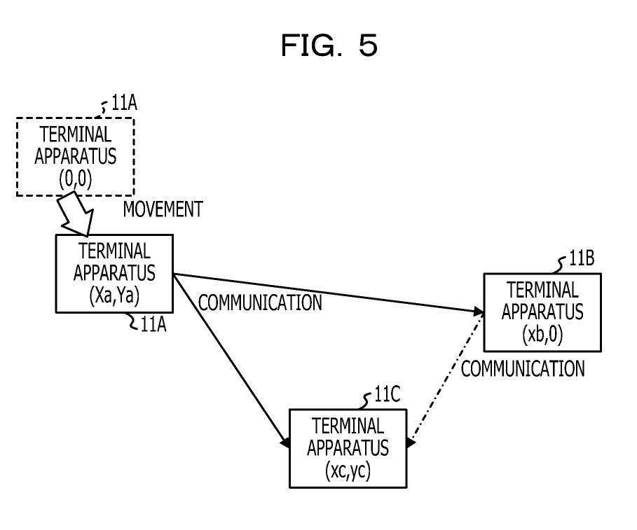

When the terminal apparatus 11A has moved from a position indicated by a broken line in FIG. 5 to a position indicated by a solid line, the movement direction & distance measuring unit 33 measures (or obtains) a movement direction 8 and a movement distance r of the terminal apparatus 11A on the basis of detected information obtained by the gyro sensor 119 and the acceleration sensor 117 of the terminal apparatus 11A or detected information obtained by the geomagnetic sensor 118 and the acceleration sensor 117 using a known method. The movement direction 8 is, for example, an angle relative to the x axis (y=0) on the xy plane. FIG. 5 is a diagram illustrating an example of operations according to the first embodiment. In the example illustrated in FIG. 5, the terminal apparatus 11A moves from a position having coordinates (0, 0) to a position having coordinates (Xa, Ya). Here, Xa=r·cos θ and Ya=r·sin θ, where θ, r, Xa, and Ya denote information relating to the coordinates of the position of the terminal apparatus 11A obtained from the detected information obtained by the gyro sensor 119 or the geomagnetic sensor 118. Thus, movement information MI_{B} including the movement direction and distance of the terminal apparatus 11A may be obtained.

The relative direction identification unit 34 communicates with the terminal apparatus 11B and the terminal apparatus 11C from the terminal apparatus 11A after the movement, and obtains the RSSI values after the movement between the terminal apparatus 11A and both the terminal apparatus 11B and the terminal apparatus 11C, in order to calculate new distances d_AB′ and d_AC′ between the terminal apparatuses 11A and 11B and between the terminal apparatuses 11A and 11C, respectively. In addition, the relative direction identification unit 34 may obtain a position RP_{S} of the terminal apparatus 11A after the movement relative to the terminal apparatus 11B and the terminal apparatus 11C. Therefore, it is possible to obtain the relative directions of the terminal apparatuses 11B and 11C from the terminal apparatus 11A. If the distance between the terminal apparatuses 11A and 11B becomes smaller after the movement of the terminal apparatus 11A, it indicates that the terminal apparatus 11B exists in a direction in which the terminal apparatus 11A has moved, and the direction of the terminal apparatus 11C may also be identified on the basis of the direction of the terminal apparatus 11B. More specifically, a new position (xa, ya) of the terminal apparatus 11A in the original relative coordinate system may be calculated using the following simultaneous equations.

d_{—}AB′²=(xa−xb)²+(ya−yb=0)²

d_{—}AC′²=(xa−xc)²+(ya−yc)²

On the basis of the coordinate transformation (rotation) between the coordinates (Xa, Ya) and the coordinates (xa, ya), the rotational angle between the coordinates viewed from the gyro sensor 119 or the geomagnetic sensor 118 and the relative coordinate obtained in the relative position identification unit 32 are calculated, and finally the positions and the directions of the terminal apparatus 11B and the terminal apparatus 11C relative to the terminal apparatus 11A are obtained.

Thus, each terminal apparatus 11 communicates with other terminal apparatuses 11 and obtains RSSI values in relation to the other terminal apparatuses 11 using the radio field intensity state obtaining unit 31. On the basis of the RSSI values at this time, relative positions of the terminal apparatuses 11 after movement are identified through calculation by the relative position identification unit 32. The relative positions and directions of the terminal apparatuses 11 may be identified on the basis of the relative positions of the terminal apparatuses 11 identified by the relative position identification unit 32, the changes in the relative positions of the terminal apparatuses 11 identified by the relative direction identification unit 34, and the movement directions measured by the movement direction & distance measuring unit 33. Therefore, even when there is no base station or the like that serves as a reference for identifying the positions of the terminal apparatuses 11, the relative positions and directions of the terminal apparatuses 11 may be automatically identified.

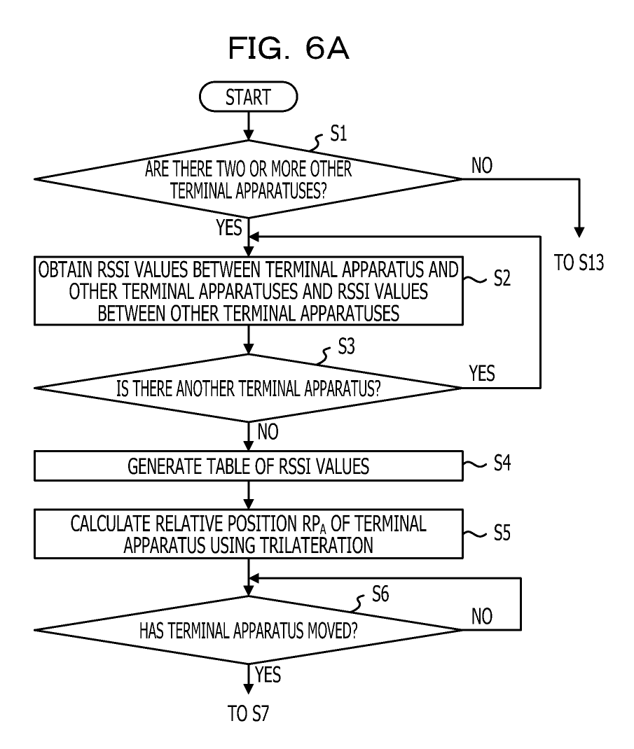

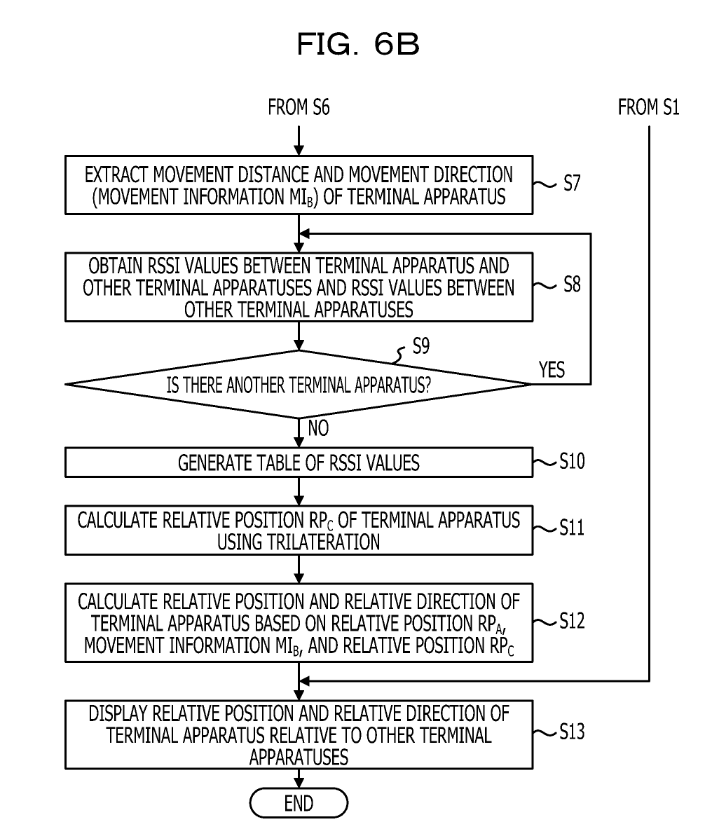

FIGS. 6A and 6B are flowcharts illustrating an example of operations according to the first embodiment. Processing illustrated in FIGS. 6A and 6B is, for example, executed by the CPU 111 illustrated in FIG. 3 in the terminal apparatus 11A. The processing illustrated in FIGS. 6A and 6B begins, for example, when the terminal apparatus 11A has entered an area in which communication with the other terminal apparatuses 11B and 11C is possible and the user has input an instruction for measuring a position by operating the input device 116 of the terminal apparatus 11A. The instruction for measuring a position for the terminal apparatus 11A may be input by, for example, operating a key such as a position measuring button (not illustrated) on the input device 116. The processing illustrated in FIGS. 6A and 6B may, for example, automatically begin every time after an elapse of a certain period of time.

In S1, the radio field intensity state obtaining unit 31, for example, determines whether or not there are two or more other terminal apparatuses around the terminal apparatus 11A. Whether there are two or more other terminal apparatuses around the terminal apparatus 11A may be determined using a known method such as, for example, counting identification information transmitted from terminal apparatuses capable of communicating with the terminal apparatus 11A. When a result of the determination in S1 is NO, the processing proceeds to S13, which will be described later. When the terminal apparatuses 11B and 11C are present around the terminal apparatus 11A, the result of the determination in S1 is YES, and the processing proceeds to S2.

In S2, the radio field intensity state obtaining unit 31 obtains the RSSI values between the terminal apparatus 11A and both the other terminal apparatuses 11B and 11C and the RSSI value between the other terminal apparatuses 11B and 11C, and stores the RSSI values in, for example, the RAM 113.

In S3, the radio field intensity state obtaining unit 31 determines whether or not there is another terminal apparatus. When a result of the determination in S3 is YES, the processing returns to S2. When the result of the determination in S3 is NO, the processing proceeds to S4.

In S4, the radio field intensity state obtaining unit 31 generates a table of the RSSI values and stores the table in, for example, the RAM 113.

In S5, the relative position identification unit 32 identifies a relative position RP_{A} of the terminal apparatus 11A relative to the terminal apparatuses 11B and 11C through calculation using trilateration, and stores the relative position RP_{A} in, for example, the RAM 113.

In S6, the movement direction & distance measuring unit 33 determines whether or not the terminal apparatus 11A has moved. When a result of the determination is NO, the processing returns to S6. When the result of the determination in S6 is YES, the processing proceeds to S7.

In S7, the movement direction & distance measuring unit 33 measures the movement distance and the movement direction of the terminal apparatus 11A, and stores resulting movement information MI_{B} in, for example, the RAM 113.

In S8, the radio field intensity state obtaining unit 31 obtains the RSSI values between the terminal apparatus 11A and both the terminal apparatuses 11B and 11C and the RSSI value between the other terminal apparatuses 11B and 11C, and stores the RSSI values in, for example, the RAM 113.

In S9, the radio field intensity state obtaining unit 31 determines whether or not there is another terminal apparatus. When a result of the determination in S9 is YES, the processing returns to S8. When the result of the determination in S9 is NO, the processing proceeds to S10.

In S10, the radio field intensity state obtaining unit 31 generates a table of the RSSI values.

In S11, the relative position identification unit 32 identifies a relative position RP_{C} of the terminal apparatus 11A after the movement relative to the terminal apparatuses 11B and 11C through calculation using trilateration, and stores the relative position RP_{C} in, for example, the RAM 113.

In S12, the relative direction identification unit 34 identifies the relative position and the relative direction of the terminal apparatus 11A relative to the terminal apparatuses 11B and 11C through calculation on the basis of the relative position RP_{A}, the movement information MI_{B}, and the relative position RP_{C} stored in the RAM 113, and stores the relative position and the relative direction in, for example, the RAM 113.

In S13, the relative direction identification unit 34, for example, reads the relative position and the relative direction of the terminal apparatus 11A relative to the other terminal apparatuses 11B and 11C from the RAM 113, and causes the display device 115 of the terminal apparatus 11A to display the relative position and the relative direction. The processing then ends.

### Second Embodiment

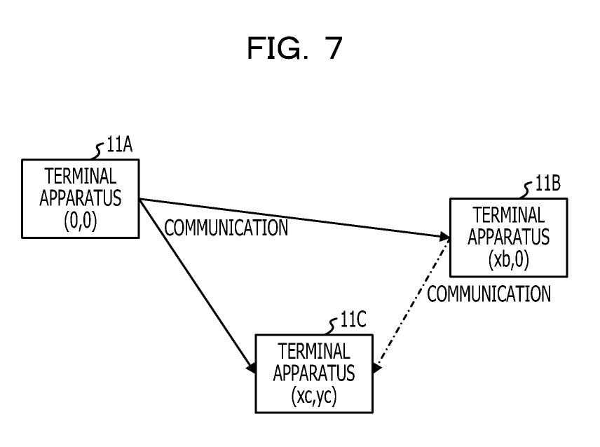

Next, a second embodiment will be described with reference to FIGS. 7 to 9. When the terminal apparatuses 11B and 11C other than the terminal apparatus 11A also move, it is possible to identify the relative position and the relative direction of the terminal apparatus 11A relative to the other terminal apparatuses 11B and 11C as with the first embodiment by detecting the movement distances and the movement directions of the other terminal apparatuses 11B and 11C after the movement.

FIG. 7 is a diagram illustrating an example of operations according to the second embodiment. In this example, it is assumed that three or more terminal apparatuses perform ad hoc communication, and FIG. 7 illustrates a case in which three terminal apparatuses 11A, 11B, and 11C communicate with one another while each moving. For convenience of description, the coordinates of the position of the terminal apparatus 11 before the movement are assumed to be (0, 0), the coordinates of the position of the terminal apparatus 11B before the movement are assumed to be (xb, 0), and the coordinates of the position of the terminal apparatus 11C before the movement are assumed to be (xc, yc). The terminal apparatuses 11A, 11B, and 11C have configurations that enable wireless communication.

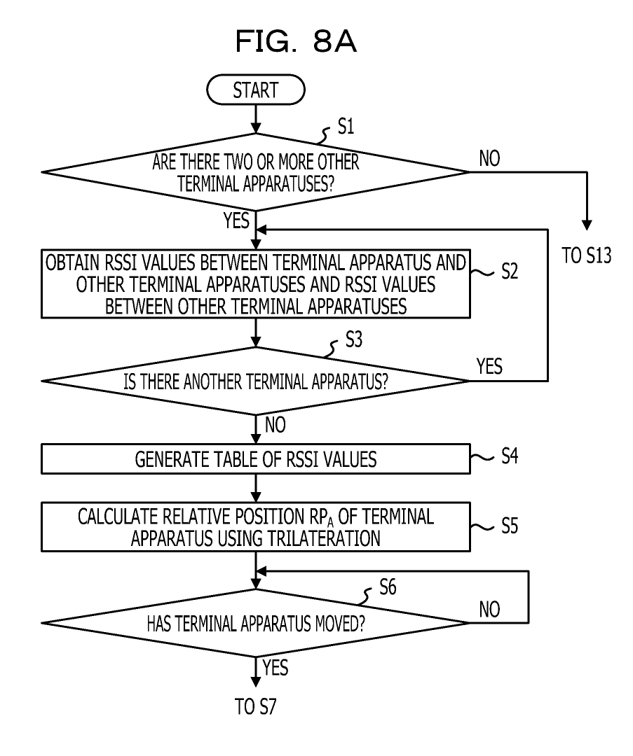

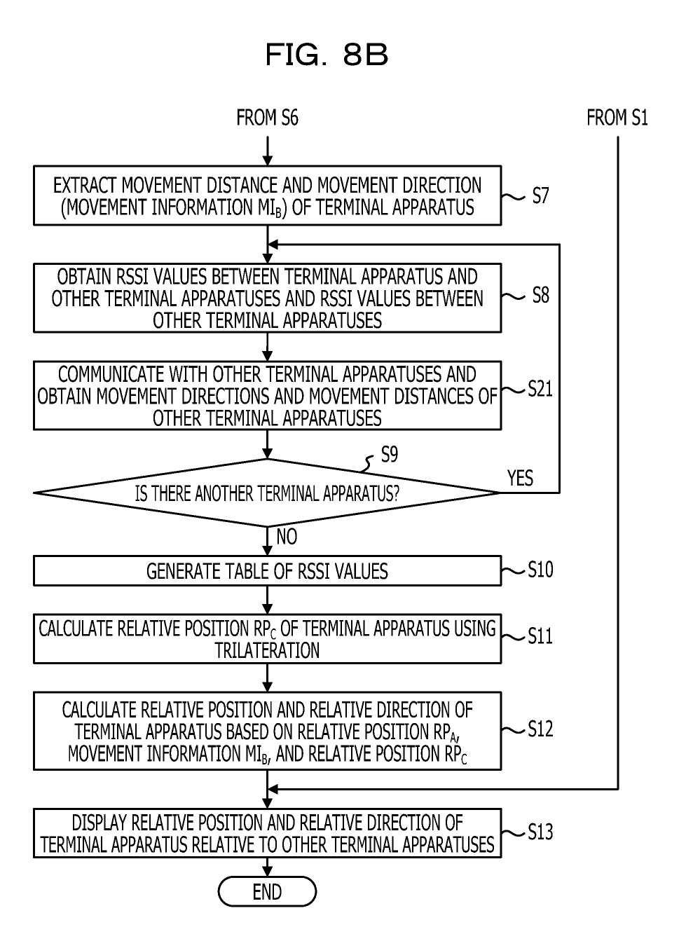

FIGS. 8A and 8B are flowcharts illustrating an example of operations according to the second embodiment. In FIGS. 8A and 8B, the same processing as in FIGS. 6A and 6B are given the same reference numerals, and description thereof is omitted. In FIGS. 8A and 8B, S21 is executed between S8 and S9.

In S21, the terminal apparatus 11A communicates with the other terminal apparatuses 11B and 11C, and stores the movement directions and the movement distances of the other terminal apparatuses 11B and 11C, which have been measured by the respective movement direction & distance measuring units 33 in, for example, the RAM 113.

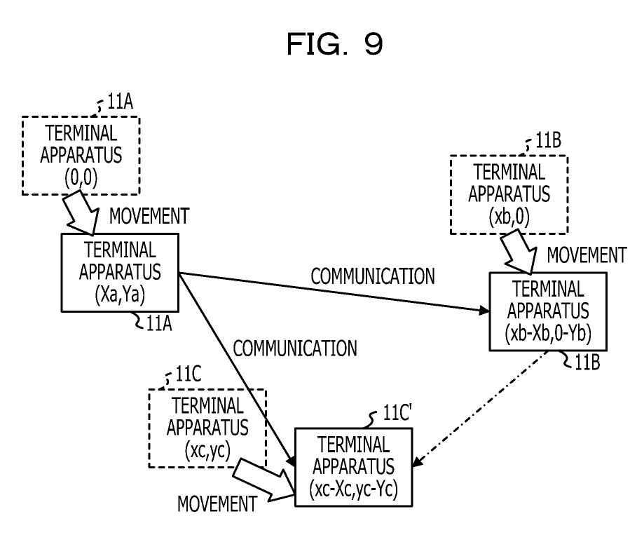

FIG. 9 is a diagram illustrating an example of operations according to the second embodiment. FIG. 9 illustrates a case in which the terminal apparatus 11A moves from the position having the coordinates (0, 0) to a position having coordinates (Xa, Ya), the terminal apparatus 11B moves from the position having the coordinates (Xb, 0) to a position having coordinates (xb−Xb, 0−Yb), and the terminal apparatus 11C moves from the position having the coordinates (xc, yc) to a position having coordinates (xc−Xc, yc−Yc).

Since the terminal apparatuses 11A, 11B, and 11C each include the gyro sensor 119 or the geomagnetic sensor 118 and the acceleration sensor 117, even if the terminal apparatuses 11B and 11C other than the terminal apparatus 11A move, the movement distances and the movement directions of the other terminal apparatuses 11B and 11C may be transmitted to the terminal apparatus 11A when the terminal apparatus 11A and the other terminal apparatuses 11B and 11C communicate with each other to obtain the respective RSSI values. Therefore, after the relative position identification unit 32 identified the relative positions of the terminal apparatuses 11A, 11B, and 11C, the respective movement direction & distance measuring units 33 measure the movement distances and the movement directions of the terminal apparatuses 11A, 11B, and 11C, the relative position identification unit 32 identify again the relative positions of the terminal apparatuses 11A, 11B, and 11C, and then the relative positions and the relative directions of the terminal apparatuses 11A, 11B, and 11C may be identified on the basis of changes in the relative positions of the terminal apparatuses 11A, 11B, and 11C measured by the relative direction identification unit 34 and movement directions of the terminal apparatuses 11A, 11B, and 11C measured by the respective movement direction & distance measuring unit 33. That is, by executing the processing using the radio field intensity state obtaining unit 31, the relative position identification unit 32, the movement direction & distance measuring unit 33, the radio field intensity state obtaining unit 31, the relative position identification unit 32, and the relative direction identification unit 34 in this order, the relative positions and the relative directions of the terminal apparatuses 11A, 11B, and 11C may be identified.

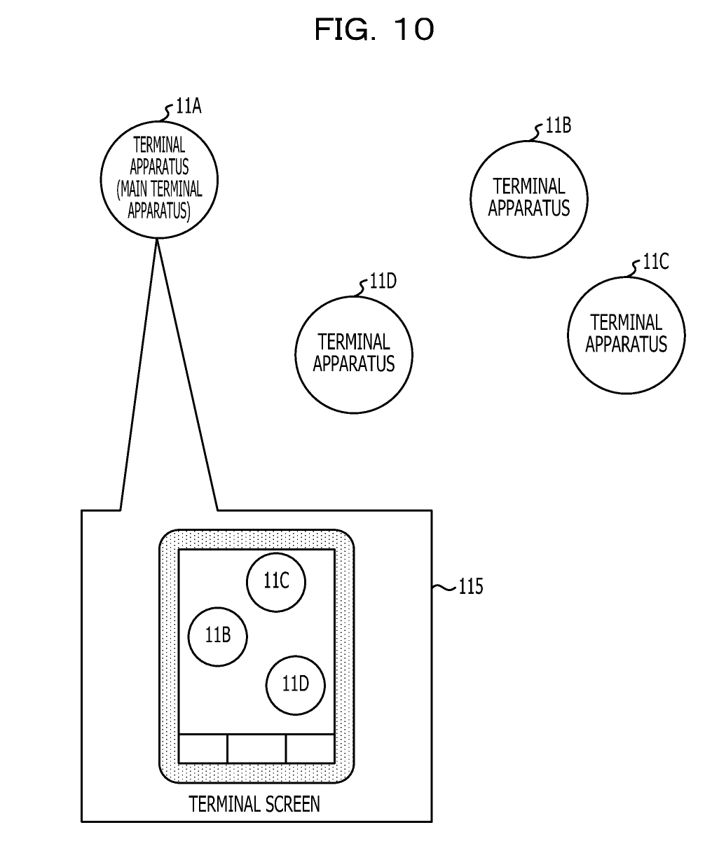

FIG. 10 is a diagram illustrating an example of a screen displayed on a display device of a terminal apparatus. FIG. 10 illustrates an example of a screen displayed on the display device 115 of the terminal apparatus 11A. In this example, because other terminal apparatuses 11B, 11C, and 11D are located at positions illustrated in FIG. 10 relative to the terminal apparatus 11A, the display device 115 displays the positional relationships using a method by which the positional relationships may be identified. In this example, the terminal apparatuses 11B, 11C, and 11D are indicated by circular marks, and identification information (“11B”, “11C”, or “11D” in this example) regarding the terminal apparatuses 11B, 11C, and 11D is displayed inside the marks.

As described above, according to the terminal apparatus and the method for identifying a position, the relative positions and the relative directions of a plurality of terminal apparatuses may be identified even if there is no base station that serves as a reference (that is, a reference for measuring a position) for identifying the positions of the terminal apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal apparatus comprising:
a processor to
obtain first information relating to communication states between the terminal apparatus and two or more other terminal apparatuses and between the two or more other terminal apparatuses,
identify using trilateration, based on the first information, first relative positional relationships between the terminal apparatus and the two or more other terminal apparatuses,
measure, based on second information detected by a sensor, a movement direction and a movement distance of the terminal apparatus when the terminal apparatus has moved,
identify second relative positional relationships between the terminal apparatus and the two or more other terminal apparatuses after the movement of the terminal apparatus, and
calculate a relative position and a relative direction of the terminal apparatus relative to the two or more other terminal apparatuses, based on the first relative positional relationships, the second relative positional relationships, and the movement distance and the movement direction of the terminal apparatus.

2. The terminal apparatus according to claim 1, wherein
the first information includes values of radio field intensity states.

3. The terminal apparatus according to claim 1, wherein
the second information is information regarding acceleration of the terminal apparatus detected by an acceleration sensor and angular speed or geomagnetism of the terminal apparatus detected by a gyro sensor or a geomagnetic sensor, respectively.

4. The terminal apparatus according to claim 1, wherein
the processor receives respective movement distances and respective movement directions from the two or more other terminal apparatuses, and
the processor calculates the relative position and the relative direction of the terminal apparatus relative to the two or more other terminal apparatuses, also based on the respective movement distances and the respective movement directions received from the two or more other terminal apparatuses.

5. A method for identifying a position of a first terminal apparatus relative to a plurality of second terminal apparatuses, the method comprising:
obtaining, by the first terminal apparatus, first information relating to communication states between the first terminal apparatus and the plurality of second terminal apparatuses and between the plurality of second terminal apparatuses;
identifying using trilateration, based on the first information, first relative positional relationships between the first terminal apparatus and the plurality of second terminal apparatuses;
measuring, based on second information detected by a sensor, a movement direction and a movement distance of the first terminal apparatus when the first terminal apparatus has moved;
identifying second relative positional relationships between the first terminal apparatus and the plurality of second terminal apparatuses after the movement of the first terminal apparatus; and
calculating a relative position and a relative direction of the first terminal apparatus relative to the plurality of second terminal apparatuses, based on the first relative positional relationships, the second relative positional relationships, and the movement distance and the movement direction of the first terminal apparatus.

6. The method according to claim 5, wherein
the first information includes values of radio field intensity states.

7. The method according to claim 5, wherein
the second information is information regarding acceleration of the first terminal apparatus detected by an acceleration sensor and angular speed or geomagnetism of the first terminal apparatus detected by a gyro sensor or a geomagnetic sensor, respectively.

8. The method according to claim 5, further comprising:
receiving respective movement distances and respective movement directions from the plurality of second terminal apparatuses,
wherein
the first terminal apparatus calculates the relative position and the relative direction of the first terminal apparatus relative to the plurality of second terminal apparatuses, also based on the respective movement distances and the respective movement directions received from t the plurality of second terminal apparatuses.

9. A computer-readable recording medium storing a program that causes a computer to execute a procedure, the computer being included in a first terminal apparatus, the procedure comprising:
obtaining first information relating to communication states between the first terminal apparatus and a plurality of second terminal apparatuses and between the plurality of second terminal apparatuses;
identifying using trilateration, based on the first information, first relative positional relationships between the first terminal apparatus and the plurality of second terminal apparatuses;
measuring, based on second information detected by a sensor, a movement direction and a movement distance of the first terminal apparatus when the first terminal apparatus has moved;
identifying second relative positional relationships between the first terminal apparatus and the plurality of second terminal apparatuses after the movement of the first terminal apparatus; and
calculating a relative position and a relative direction of the first terminal apparatus relative to the plurality of second terminal apparatuses, based on the first relative positional relationships, the second relative positional relationships, and the movement distance and the movement direction of the first terminal apparatus.

10. The computer-readable recording medium according to claim 9, wherein
the first information includes values of radio field intensity states.

11. The computer-readable recording medium according to claim 9, wherein
the second information is information regarding acceleration of the first terminal apparatus detected by an acceleration sensor and angular speed or geomagnetism of the first terminal apparatus detected by a gyro sensor or a geomagnetic sensor, respectively.

12. The computer-readable recording medium according to claim 9, the procedure further comprising:
receiving respective movement distances and respective movement directions from the plurality of second terminal apparatuses,
wherein
the first terminal apparatus calculates the relative position and the relative direction of the first terminal apparatus relative to the plurality of second terminal apparatuses, also based on the respective movement distances and the respective movement directions received from the plurality of second terminal apparatuses.
